(19) United States
(12) Patent Application Publication
(10) Pub. No.: US 2017/0213153 A1
(43) Pub. Date: Jul. 27, 2017

(54) SYSTEMS AND METHODS FOR EMBEDDED UNSUPERVISED FEATURE SELECTION

(71) Applicant: ARIZONA BOARD OF REGENTS ON BEHALF OF ARIZONA STATE UNIVERSITY, Tempe, AZ (US)

(72) Inventors: Suhang Wang, Mesa, AZ (US); Jiliang Tang, Mesa, AZ (US); Huan Liu, Tempe, AZ (US)

(21) Appl. No.: 15/412,909

(22) Filed: Jan. 23, 2017

Related U.S. Application Data
(60) Provisional application No. 62/286,232, filed on Jan. 22, 2016.

(51) Int. Cl. G06N 99/00; G06F 17/30

(52) U.S. Cl. CPC G06N 99/005; G06F 17/30598

(57) ABSTRACT

Systems and methods for executing an unsupervised feature selection algorithm on a processor which directly embeds feature selection into a clustering algorithm using sparse learning are disclosed. The direct embedding of the feature selection, via sparse learning, reduces storage requirement of collected data. In one method, unsupervised feature selection may be accomplished through a removal of redundant, irrelevant, and/or noisy features of incoming high-dimensional data.

### CROSS REFERENCE TO RELATED APPLICATIONS

This is a non-provisional application that claims benefit to U.S. provisional application Ser. No. 62/286,232 filed on Jan. 22, 2016, which is herein incorporated by reference in its entirety.

### GOVERNMENT SUPPORT

This presently disclosed technology was made with government support under government contract no. 1217466 awarded by the National Science Foundation. The government has certain rights in the presently disclosed technology.

### FIELD

The present disclosure generally relates to sparse learning and in particular to system and methods for sparse learning using embedded unsupervised feature selection.

### BACKGROUND

Data mining, machine learning, and other algorithms often involve high-dimensional data. In many cases, working with high dimensional data not only significantly increases processing time and memory requirements of the algorithms but degenerates performance of the algorithms due to the curse of dimensionality and the existence of irrelevant, redundant and noisy dimensions. Feature selection, which reduces the dimensionality by selecting a subset of most relevant features, is often utilized as an effective and efficient way to handle high dimensional data. In terms of the label availability, feature selection methods can be broadly classified into supervised methods and unsupervised methods. The availability of the class label allows supervised feature selection algorithms to effectively select discriminative features to distinguish samples from different classes. Sparse learning may be a powerful technique in supervised feature selection, which enables feature selection to be embedded in the classification (or regression) problem. However, supervised feature selection often expends significant resources because most data is unlabeled, and it is very expensive to label the data.

Without label information to define feature relevance, a number of alternative criteria have been proposed for unsupervised feature selection. One commonly used criterion is to select features that can preserve the data similarity or manifold structure constructed from the whole feature space. Alternatively or additionally, as can be understood from FIG. 1A, conventional methods of applying sparse learning in unsupervised feature selection usually generate cluster labels via clustering algorithms and then transform unsupervised feature selection into sparse learning based supervised feature selection with these generated cluster labels, such as multi-cluster feature selection, Nonnegative Discriminative Feature Selection (NDFS), and Robust Unsupervised Feature Selection (RUFS). Such methods typically have increased computational cost and/or decreased clustering performance. It is with these observations in mind, among others, that various aspects of the present disclosure were conceived and developed.

### BRIEF DESCRIPTION OF THE DRAWINGS

FIG. 1A is illustrates a prior art sparse learning technique based on unsupervised feature selection methods.

FIG. 1B illustrates spare learning using embedded unsupervised feature selection in accordance with an implementation of the presently disclosed technology.

FIGS. 2A-2D are graphs illustrating ACC and NMI of EUFS with different α, β and feature numbers on datasets COIL20.

FIG. 3 depicts an example network environment that may implement various systems and methods of the presently disclosed technology.

FIG. 4 shows an example computing system that may implement various systems and methods of the presently disclosed technology.

Corresponding reference characters indicate corresponding elements among the view of the drawings. The headings used herein do not limit the scope of the claims.

### DETAILED DESCRIPTION

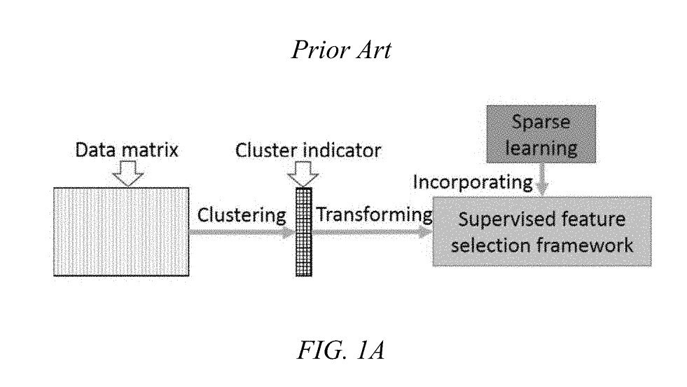

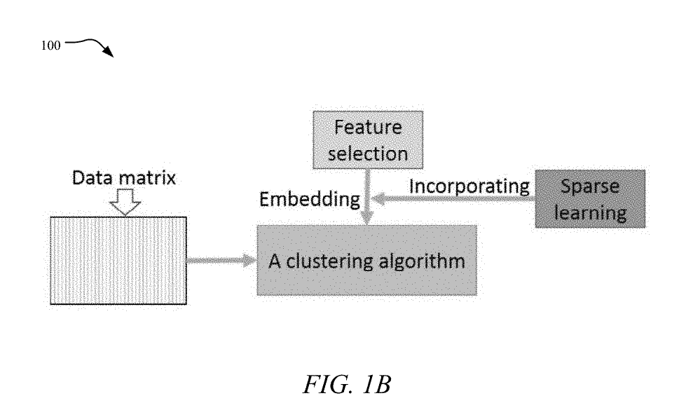

Aspects of the present disclosure involve systems and methods of unsupervised feature selection using an Embedded Unsupervised Feature Selection (EUFS). Unlike existing unsupervised feature selection methods, such as MCFS, NDFS or RUFS, which transform unsupervised feature selection into sparse learning based supervised feature selection with cluster labels generated by clustering algorithms, the feature selection of the presently disclosed technology is directly embedded into a clustering algorithm via sparse learning without the transformation as shown in FIG. 1A. The EUFS thus extends the current state-of-the-art unsupervised feature selection and algorithmically expands the capability of the same. An empirical demonstration of the efficacy of the EUFS is provided herein.

In one aspect, the systems and methods described herein directly embed unsupervised feature selection algorithm into a clustering algorithm via sparse learning instead of transforming it into sparse learning based supervised feature selection with cluster labels. Further, an embedded feature selection framework is provided, which selects features in unsupervised scenarios with sparse learning. While discussed in the context of clustering, it will be appreciated that the systems and methods described herein are applicable in other contexts, such as dimensionality reduction algorithms.

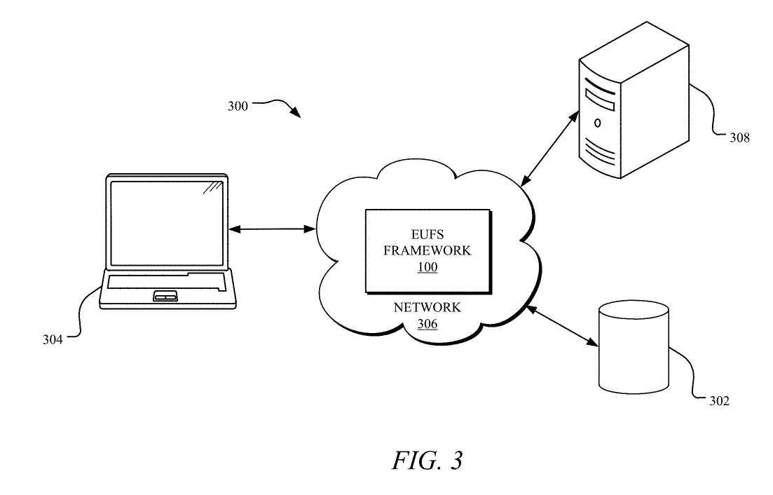

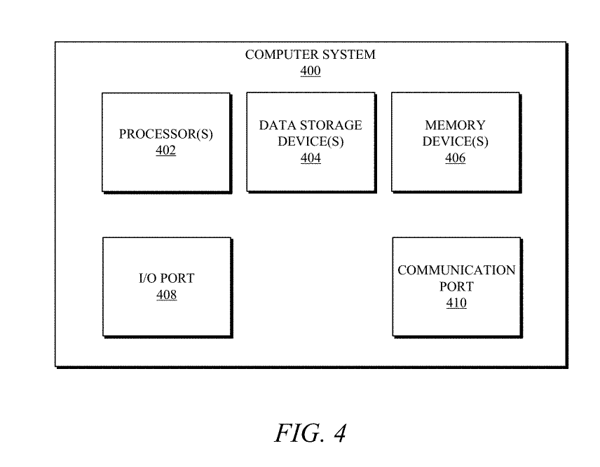

To begin a detailed description of an example EUFS framework 100, reference is made to FIG. 1B. In one implementation, a data matrix is obtained at a computing device, such as those described with respect to FIGS. 3 and 4. The data matrix has a plurality of rows with one or more features. The computing device clusters the data matrix into one or more clusters using the EUFS framework 100 by selecting the one or more features in an unsupervised environment with sparse learning. The clustering algorithm of the EUFS framework 100, as discussed in more detail below, is generated based on a cluster indicator and a latent feature matrix. In one implementation, the latent feature matrix includes a sparse learning technique for feature selection.

Systems and methods for applying an unsupervised feature selection approach, the EUFS framework 100, which directly embeds feature selection into a clustering algorithm via sparse learning, eliminates the need for transforming unsupervised feature selection into the sparse learning based supervised feature selection with pseudo labels. Nonnegative orthogonality is applied on the cluster indicator to make the problem tractable and ensure that feature selection on latent features has similar effects as on original features. As will be understood from the discussion of the EUFS framework 100 below, I₂, 1-norm is applied on the cost function to reduce the effects of the noise introduced by the reconstruction of X and feature selection on V. Experimental results on six different real world datasets validate the unique contributions of EUFS framework 100.

### Embedded Unsupervised Feature Selection

Below is a detailed description of the EUFS framework 100. Throughout this discussion, matrices are written as boldface capital letters and vectors are denoted as boldface lowercase letters. For an arbitrary matrix M ∈ [symbol] M_{G} denotes the (i, j)-th entry of M while mᵢ and m^{j} mean the i-th row and j-th column of M respectively. ∥M∥_{F} is the Frobenius norm of M and Tr(M) is the trace of M if M is square. (A, B) equals Tr(A^{T}B), which is the standard inner product between two matrices. I is the identity matrix and 1 is a vector whose elements are all 1. The l_{2,1}-norm is defined as ∥M∥_{2,1}=Σᵢ₌₁^{m}∥mᵢ∥=Σᵢ₌₁^{m}{square root over (Σⱼ₌₁ⁿMᵢⱼ²).)}

Let X ∈ [symbol] be the data matrix with each row xᵢ ∈ [symbol] being a data instance. [symbol] ={f₁, . . . , f_{d}} may be used to denote the d features and f₁, . . . , fd are the corresponding feature vectors. Assume that each feature has been normalized, i.e., ∥fⱼ∥₂=1 for j=1, . . . , d. Suppose it is desired to cluster X into k clusters (C₁, C₂, . . . , Cₖ,) under the matrix factorization framework as:

$${min}_{U , V} {‖ X - {UV}^{T} ‖}_{F}^{2} \\ s . t . U ∈ {\{ 0 , 1 \}}^{N \times k} , {U}^{T} 1 = 1 \qquad ( 1 )$$

where U ∈ [symbol] is the cluster indicator and V ∈ [symbol] is the latent feature matrix. The problem in Equation(1) is difficult to solve due to the constraint on U. Following the common relaxation for label indicator matrix, the constraint on U is relaxed to orthogonality, i.e., U^{T}U=I, U≧0. After the relaxation, Equation (1) can be rewritten as:

$${min}_{U , V} {‖ X - {UV}^{T} ‖}_{F}^{2} \\ s . t . {U}^{T} U = I , U \geq 0 \qquad ( 2 )$$

Another significance of the orthogonality constraint on U is to allow the EUFS framework 100 to perform feature selection via V, which can be stated by the follow theorem:
Theorem 1. Let X={f₁, f₂, . . . , f_{d}}, and ∥fⱼ∥=1 for i=1, . . . , d. We use UV^{T} to reconstruct X, i.e., \hat{X}=UV^{T}. If U is orthogonal, then we can perform feature selection via V can be performed.

Proof. Since \hat{X}=UV^{T}, we have: \hat{f}ᵢ=Uvᵢ^{T}. Then

∥\hat{f}ᵢ∥₂=∥Uvᵢ^{T}∥₂=(vᵢU^{T}Uvᵢ)^{1/2}=∥vᵢ∥₂ (3)

Consider the case that ∥vᵢ∥₂ is close to 0, which indicates that the reconstructed feature representation ∥\hat{f}ᵢ∥_{z} is close to 0. ∥fᵢ∥=1 means fᵢ is not well reconstructed via which suggests that this corresponding feature could be not representative and such features should be excluded to have a better reconstruction. One way to do this is to add a selection matrix diag(p) to X and V as,

∥Xdiag(p)−U(diag(p)V)^{T}∥_{F}² (4)

where p={0, 1}^{d} with pᵢ=1 if the i-th feature is selected and otherwise pᵢ=0, which completes the proof.

With Theorem 1, if we want to select m, features for the clustering algorithm in Equation (2), we can rewrite it as:

$${min}_{U , V} {‖ X diag ( p ) - {U ( diag ( p ) V )}^{T} ‖}_{F}^{2} \\ s . t . {U}^{T} U = I , U \geq 0 \\ p ∈ {\{ 0 , 1 \}}^{d} , {p}^{T} 1 = m \qquad ( 5 )$$

The constraint on p makes Equation (5) mixed integer programming, which is difficult to solve. The problem is relaxed in the following way. First, the following theorem suggests that we can ignore the selection matrix on X as

$${min}_{U , V} {‖ X - {U ( diag ( p ) V )}^{T} ‖}_{F}^{2} \\ s . t . {U}^{T} U = I , U \geq 0 \\ p ∈ {\{ 0 , 1 \}}^{d} , {p}^{T} 1 = m \qquad ( 6 )$$

Theorem 2. The optimization problems in Equation (5) and Equation (6) are equivalent.

Proof. One way to prove Theorem 2 is to show that the objective functions in Equation (5) and Equation (6) are equivalent. For Equation (5):

$$\begin{matrix}{‖ X diag ( p ) - {U ( diag ( p ) V )}^{T} ‖}_{F}^{2} = {\sum }_{i = 1}^{d} {‖ {p}_{i} {f}_{i} - {p}_{i} {Uv}_{i}^{T} ‖}_{F}^{2} \\ = {\sum }_{i : {p}_{i} = 1} {‖ {f}_{i} - {Uv}_{i}^{T} ‖}_{F}^{2}\end{matrix} \qquad ( 7 )$$

### And for Equation (6):

$$\begin{matrix}{‖ X - {U ( diag ( p ) V )}^{T} ‖}_{F}^{2} = {\sum }_{i = 1}^{d} {‖ {f}_{i} - {p}_{i} {Uv}_{i}^{T} ‖}_{F}^{2} \\ = {\sum }_{i : {p}_{i} = 1} {‖ {f}_{i} - {Uv}_{i}^{T} ‖}_{F}^{2} + ( N - m )\end{matrix} \qquad ( 8 )$$

which complete the proof.

It's observed that diag(p) and V is as the form of diag(p)V in Equation (6). Since p is a binary vector and N−m rows of the diag(p) are all zeros, diag(p)V is a matrix where elements of many rows are all zeros. This motivates us to absorb the diag(p) into V, i.e., V=diag(p)V, and add I_{2,1} norm on V to achieve feature selection as:

$$arg {min}_{U , V} {‖ X - {UV}^{T} ‖}_{F}^{2} + α {‖ V ‖}_{2 , 1} \\ s . t . {U}^{T} U = I , U \geq 0 \qquad ( 9 )$$

Since it forces some rows of V close to 0, U and V may poorly reconstruct some data instances. Reconstructing errors from these instances may easily dominate the objective function because of the squared errors. To make the model robust to these instances, a robust analysis should be conducted, i.e., replace the loss function by I_{2,1}-norm, as follows

$$arg {min}_{U , V} {‖ X - {UV}^{T} ‖}_{2 , 1} + α {‖ V ‖}_{2 , 1} \\ s . t . {U}^{T} U = I , U \geq 0 \qquad ( 10 )$$

To take advantage of information from attribute-value part, i.e, X, similar data instances should have similar labels, according to the spectral analysis, the following term to force is added similar instances with similar labels as:

min Tr(U^{T}LU) (11)

where L=D−S is the Laplacian matrix and D is a diagonal matrix with its elements defined as Dᵤ=Σⱼ₌₁ⁿ\check{S}ᵢⱼ. S ∈ [symbol] denotes the similarity matrix based on X, which is obtained through RBF kernel as

$${S}_{ij} = {e}^{- \frac{{‖ {x}_{1} - {x}_{2} ‖}^{2}}{{σ}^{2}}} \qquad ( 12 )$$

Putting Equation (10) and Equation (11) together, the proposed framework EUFS is to solve the following optimization problem:

$$arg {min}_{U , V} {‖ X - {UV}^{T} ‖}_{2 , 1} + α {‖ V ‖}_{2 , 1} + β Tr ( {U}^{T} LU ) \\ s . t . {U}^{T} U = I , U \geq 0 \qquad ( 13 )$$

### Optimization Algorithm

The objective function in Equation (13) is not convex in both U and V but is convex if we update the two variables alternatively. The presently disclosed technology uses an Alternating Direction Method of Multiplier to optimize the objective function. By introducing two auxiliary variables E=X−UV^{T} and Z=U, Equation (13) is converted into the following equivalent problem,

$$arg {min}_{U , V , E , Z} {‖ E ‖}_{2 , 1} + α {‖ V ‖}_{2 , 1} + β Tr ( {Z}^{T} LU ) \\ s . t . E = X - {UV}^{T} , Z = U , {U}^{T} U = I , Z \geq 0 \qquad ( 14 )$$

which can be solved by the following ADMM problem

$${min}_{U , V , E , Z , {Y}_{1} , {Y}_{2} , μ} {‖ E ‖}_{2 , 1} + α {‖ V ‖}_{2 , 1} + β Tr ( {Z}^{T} LU ) + 〈 {Y}_{1} , Z - U 〉 + 〈 {Y}_{2} , X - {UV}^{T} - E 〉 + \frac{μ}{2} ( {‖ Z - U ‖}_{F}^{2} + {‖ X - {UV}^{T} - E ‖}_{F}^{2} ) \\ s . t . {U}^{T} U = I , Z \geq 0 \qquad ( 15 )$$

where Y1, Y2 are two Lagrangian multipliers and p is a scalar to control the penalty for the violation of equality constraints E=X−UV^{T} and Z=U.

### Update E

To update E, other variables are fixed except E and remove terms that are irrelevant to E. Then Equation (15) becomes

$${min}_{E} \frac{1}{2} {‖ E - ( X - {UV}^{T} + \frac{1}{μ} {Y}_{2} ) ‖}_{F}^{2} + \frac{1}{μ} {‖ E ‖}_{2 , 1} \qquad ( 16 )$$

The equation has a closed form solution by the following Lemma:
Lemma 3. Let Q=[q₁; q₂; . . . ; qₘ] be a given matrix and λ a positive scalar. if the the optimal solution of

$${min}_{W} \frac{1}{2} {‖ W - Q ‖}_{F}^{2} + λ {‖ W ‖}_{2 , 1} \qquad ( 17 )$$

is W*, then the i-th row of W* is

$${w}_{i}^{*} = \{ \begin{matrix}( 1 - \frac{λ}{‖ {q}_{i} ‖} ) {q}_{i} , & if ‖ {q}_{i} ‖ > λ \\ 0 , & otherwise\end{matrix} \qquad ( 18 )$$

Apparently, if

$$Q = X - {UV}^{T} + \frac{1}{μ} {Y}_{2}$$

then using Lemma 3, E can be updated as

$${e}_{i} = \{ \begin{matrix}( 1 - \frac{1}{μ ‖ {q}_{i} ‖} ) {q}_{i} , & if ‖ {q}_{i} ‖ > \frac{1}{μ} \\ 0 , & otherwise\end{matrix} \qquad ( 19 )$$

### Update V

To update V, other variables are fixed except V and remove terms that are irrelevant to V, then Equation (15) becomes min

$${min}_{V , {U}^{T} U = 1} \frac{μ}{2} {‖ X - {UV}^{T} - E + \frac{1}{μ} {Y}_{2} ‖}_{F}^{2} + α {‖ V ‖}_{2 , 1} \qquad ( 20 )$$

Using the fact that U^{T}U=I, we can reformulate Eq.(20) as

$${min}_{V} \frac{1}{2} {‖ V - {( X - E + \frac{1}{μ} {Y}_{2} )}^{T} U ‖}_{F}^{2} + \frac{α}{μ} {‖ V ‖}_{2 , 1} \qquad ( 21 )$$

Again, the above equation has a closed form solution according to Lemma 3.

$$Let K = {( X - E + \frac{1}{μ} {Y}_{2} )}^{T} U ,$$

then

$${V}_{i} = \{ \begin{matrix}( 1 - \frac{α}{μ ‖ {k}_{i} ‖} ) {k}_{i} , & if ‖ {k}_{i} ‖ > \frac{α}{μ} \\ 0 , & otherwise\end{matrix} \qquad ( 22 )$$

### Update Z

Similarly, to update Z, we fix U, V, E, Y₁, Y₂, μ and remove terms irrelevant to Z, then Equation (15) becomes

$${min}_{Z \geq 0} \frac{μ}{2} {‖ Z - U ‖}_{F}^{2} + β Tr ( {Z}^{T} LU ) + 〈 {Y}_{1} , Z - U 〉 \qquad ( 23 )$$

Equation (23) may be rewritten by putting the second and third terms to the quadratic term and get a compact form

$${min}_{Z \geq 0} {‖ Z - T ‖}_{F}^{2} \qquad ( 24 )$$

where T is defined as

$$T = ( U - \frac{1}{μ} {Y}_{1} - \frac{β}{μ} LU ) \qquad ( 25 )$$

Equation (24) can be further decomposed to element-wise optimization problems as

$${min}_{{Z}_{ij} \geq 0} {( {Z}_{ij} - {T}_{ij} )}^{2} \qquad ( 26 )$$

Clearly, the optimal solution of the above problem is

Zᵢⱼ=max(Tᵢⱼ, 0)

### Update U

Optimizing Equation (15) with respect to U yields the equation

$${min}_{{U}^{T} U = 1} 〈 {Y}_{1} , Z - U 〉 + 〈 {Y}_{2} , X - {UV}^{T} - E 〉 + \frac{μ}{2} ( {‖ Z - U ‖}_{F}^{2} + {‖ X - {UV}^{T} - E ‖}_{F}^{2} ) + β Tr ( {Z}^{T} LU ) \qquad ( 28 )$$

By expanding Equation (28) and dropping terms that are independent of U, the following equation (29) is arrived at:

$${min}_{{U}^{T} U = 1} \frac{μ}{2} {‖ U ‖}_{F}^{2} - μ 〈 N , U 〉 \qquad ( 29 )$$

where N is defined as

$$N = \frac{1}{μ} {Y}_{1} + Z - β LZ + ( X - E + \frac{1}{μ} {Y}_{2} ) V \qquad ( 30 )$$

The above equation may be written into a more compact form as:

$${min}_{{U}^{T} U = 1} {‖ U - N ‖}_{F}^{2} \qquad ( 31 )$$

And now the objective function of updating U has been converted to the classical Orthogonal Procrutes problem and can be solved using the following lemma:
Lemma 4. Given the objective in Eq.(31), the optimal U is defined as

U=PQ^{T} (32)
where P and Q are the left and right singular vectors of the economic singular value decomposition (SVD) of N.

### Update Y1, Y2 and μ

After updating the variables, as known, the ADMM parameters may be updated as follows:

Y₁=Y₁+μ(Z−U) (33)

Y₂=Y₂+μ(X−UV^{T}−E) (34)

μ=max(ρμ, μₘₐₓ) (35)

Here, ρ>1 is a parameter to control the convergence speed and μₘₐₓ is a larger number to prevent μ becomes too large.

With these updating rules, EUFS algorithm is summarized in Algorithm 1.

Algorithm 1 Embedded Unsupervised Feature Selection

```
Input: X ∈ [symbol]  , α, β, n, latent dimensional k
Output: n features for the dataset
  1: Initialize μ = 10⁻³, ρ = 1.1, μmax = 10¹⁰, U = 0, V = 0 (or initialized
    using K-means)
  2: repeat
  $3 \text{:} Calculate Q = X - {UV}^{T} + \frac{1}{μ} {Y}_{2}$
  $\begin{matrix}4 \text{:} Update E & ( 36 ) \\ {e}_{i} = \{ \begin{matrix}( 1 - \frac{1}{μ ‖ {q}_{i} ‖} ) {q}_{i} , & if ‖ {q}_{i} ‖ > \frac{1}{μ} \\ 0 , & otherwise\end{matrix} & \end{matrix}$
  $5 \text{:} Calculate K = {( X - E + \frac{1}{μ} {Y}_{2} )}^{T} U$
  $\begin{matrix}6 \text{:} Update V & ( 37 ) \\ {v}_{i} = \{ \begin{matrix}( 1 - \frac{α}{μ ‖ {k}_{i} ‖} ) {k}_{i} , & if ‖ {k}_{i} ‖ > \frac{α}{μ} \\ 0 , & otherwise\end{matrix} & \end{matrix}$
  7: Calculate T using Eq. (25)
  8: Update Z using Eq. (27)
  9: Calculate N according to Eq. (30)
10: Update U by Lemma 4
11: Update Y₁, Y₂, μ
12: until convergence
13: Sort each feature of X according to IIv_{iII2} in descending order and
    select the top-n ranked ones
```

### Parameter Initialization

One way to initialize U and V is to simply set them to be 0. As the algorithm runs, the objective function will gradually converge to the optimal value. To accelerate the convergence speed, following the common way of initializing NMF, k-means is used to initialize U and V. In some embodiments, k-means is applied to cluster rows of X and get the soft cluster indicator U. V is simply set as X^{T}U. μ is typically set in the range of 10⁻⁶ to 10⁻³ initially depending on the datasets and is updated in each iteration. μₘₐₓ is set to be a large value such as 10¹⁰ to give μ freedom to increase but prevent it from being too large. ρ is empirically set to 1.1 in the algorithm executed by the systems and methods of the present presently disclosed technology. The larger ρ is, the faster μ becomes larger and the more the deviation of the equality constraint is penalized, which makes it converges faster. However, some precision of the final objective function with large ρ is sacrificed.

### Convergence Analysis

The convergence of the algorithm depends on the convergence of the ADMM. The detailed convergence proof of ADMM can be found is known in the art. The convergence criteria can be set as

$$\frac{\vert {J}_{t + 1} - {J}_{t} \vert}{{J}_{t}} < ∈ ,$$

where Jₜ is the objective function value in Equation (14) and f is some tolerance value. In practice, the number of iterations can be controlled by setting a maximum iteration value. The experiments that were conducted found that the developed algorithm converges within 110 iterations for all the datasets that were used.

### Time Complexity Analysis

The computation cost for E depends on the computation of

$$Q = X - {UV}^{T} + \frac{1}{μ} {Y}_{2}$$

and update of E. Since U is sparse, i.e., each row of U only has one nonzero element, then the computation cost is O(Nd) and O(Nd), respectively.

Similarly, the computation cost for V involves the computation of

$$K = {( X - E + \frac{1}{μ} {Y}_{2} )}^{T} U$$

and update of V, which is O(Nd) again due to the sparsity of U.

The main computation cost for Z is the computation of

$$T = ( U - \frac{1}{μ} {Y}_{1}^{T} - \frac{β}{μ} LU )$$

which is O(k²) due to the sparsity of both U and L.

The main computation cost of U involves the computation of N and its SVD decomposition, which is O(Ndk) and O(Nk²). The computational cost for Y₁ and Y₂ are both O(Nd). Therefore, the overall time complexity is O(Ndk+Nk²). Since d>>k, the final computation cost if O(Ndk) for each iteration.

### Experimental Analysis

In this section, experiments were conducted to evaluate the effectiveness of EUFS. After introducing datasets and experimental settings, the EUFS framework 100 was compared with the state-of-the-art unsupervised feature selection methods. Further experiments were conducted to investigate the effects of important parameters on the EUFS framework 100.

### Datasets

The experiments are conducted on six publicly available benchmark datasets, including one Mass Spectrometry (MS) dataset ALLAML, two microarray datasets, i.e., Prostate Cancer gene expression (Prostate-GE) and TOX-171, two face image datasets, i.e., PIX1OP and PIE10P and one object image dataset COIL20. The statistics of the datasets used in the experiments are summarized in Table 1.

TABLE 1
Statistics of the Dataset

| Dataset | # of Samples | # of Features | # of Classes |
|---|---|---|---|
| ALLAML | 72 | 7192 | 2 |
| COIL20 | 1440 | 1024 | 20 |
| PIE1OP | 210 | 1024 | 10 |
| TOX-171 | 171 | 5748 | 4 |
| PIX1OP | 100 | 10000 | 10 |
| Prostate-GE | 102 | 5996 | 2 |

### Experimental Settings

Following the common way to evaluate unsupervised feature selection algorithms, the EUFS framework 100 was assessed in terms of clustering performance. The EUFS framework 100 was compared with the following representative unsupervised feature selection algorithms:

All Features: All original features are adopted

LS: Laplacian Score which evaluates the importance of a feature through its power of locality preservation

MCFS: Multi-Cluster Feature Selection which selects features using spectral regression with I₁-norm regularization

NDFS: Nonnegative Discriminative Feature Selection which selects features by a joint framework of nonnegative spectral analysis and 1_{2,1} regularized regression

RUFS: Robust Unsupervised Feature Selection which jointly performs robust label learning via local learning regularized robust orthogonal non-negative matrix factorization and robust feature learning via joint I_{2,1}-norms minimization.

Two widely used evaluation metrics, accuracy (ACC) and normalized mutual information (NMI), are employed to evaluate the quality of clusters. The larger ACC and NMI are, the better performance is.

There are some parameters to be set. Following, for LS, MCFS, NDFS, RUFS and EUFS, the neighborhood size was fixed to be 5 for all the datasets. To fairly compare different unsupervised feature selection methods, the parameters were tuned for all methods by a “grid-search” strategy from {10⁻⁶, 10⁻⁴, . . . 10⁴, 10⁶}. For EUFS, the latent dimension was set as the number of clusters. How to determine the optimal number of selected features is still an open problem, the number of selected features was set as {50, 100, 150, . . . , 300} for all datasets. Best clustering results from the optimal parameters are reported for all the algorithms. In the evaluation, K-means was used to cluster samples based on the selected features. Since K-means depends on initialization, the experiments were repeated twenty times and the average results with standard deviation are reported.

### Experimental Results

The experimental results of different methods on the datasets are summarized in Table 2 and Table 3. We make the following observations:

TABLE 2
Clustering results(ACC % ± std) of different feature selection algorithms
on different datasets. The best results are highlighted in bold. The number
in parentheses is the number of features when the performance is achieved.

| | ALL | Laplacian | | | | |
|---|---|---|---|---|---|---|
| Dataset | Features | Score | MCFS | NDFS | RUFS | EUFS |
| ALLAML | 67.3 + 6.72 | 73.2 + 5.52 | 68.4 ± 10.4 | 69.4 + 0.00 | 72.2 + 0.00 | 73.6 ± 0.00 |
| | | (150) | (100) | (I00) | (150) | (100) |
| COIL20 | 53.6 + 3.83 | 55.2 + 2.84 | 59.7 + 4.03 | 60.114.26 | 62.7 ± 3.51 | 63.4 ± 5.47 |
| | | (250) | (250) | (300) | (150) | (100) |
| PIE | 30.8 + 2.29 | 36.0 ± 2.95 | 44.3 ± 3.20 | 40.5 + 4.51 | 42.6 + 4.61 | 46.4 ± 2.69 |
| | | (100) | (50) | (100) | (50) | (50) |
| TOX-171 | 41.5 + 3.88 | 47.5 + 133 | 42.5 ± 5.15 | 46.1 + 2.55 | 47.8 + 3.78 | 49.5 ± 2.57 |
| | | (200) | (100) | (100) | (300) | (100) |
| PDC I OP | 74.3 + 12.1 | 76.6 + 8.10 | 75.9 + 8.59 | 76.7 + 8.52 | 73.2 + 9.40 | 76.8 ± 5.88 |
| | | (150) | (200) | (200) | (300) | (150) |
| Prostate- | 58.1 + 0.44 | 57.5 + 0.49 | 57.3 ± 0.50 | 58.3 + 0.50 | 59.8 ± 0.00 | 60.4 ± 0.80 |
| GE | | (300) | (300) | (100) | (50) | (100) |

TABLE 3
Clustering results(NMI % ± std) of different feature selection algorithms
on different datasets. The best results are highlighted in bold. The number
in parentheses is the number of features when the performance is achieved.

| | ALL | Laplacian | | | | |
|---|---|---|---|---|---|---|
| Dataset | Features | Score | MCFS | NDFS | RUFS | EUFS |
| ALLAML | 8.55 ± 5.62 | 15.0 + 1.34 | 11.7 + 12.2 | 7.20 + 0.30 | 12.0 ± 0.00 | 15.1 ± 0.00 |
| | | (100) | (50) | (300) | (150) | (100) |
| COIL20 | 70.6 + 1.95 | 70.3 + 1.73 | 72.4 + 1.90 | 72.1 + 1.75 | 73.1 + 1.69 | 77.2 + 2.75 |
| | | (300) | (150) | (300) | (150) | (100) |
| PIE1OP | 32.2 ± 3.47 | 38.5 ± 1.44 | 54.3 ± 3.39 | 46.0 + 3.14 | 49.6 ± 5.15 | 49.8 + 3.10 |
| | | (50) | (50) | (100) | (50) | (150) |
| TOX-171 | 17.815.20 | 30.5 + 2.70 | 17.7 + 6.88 | 22.3 + 2.41 | 28.8 + 2.71 | 26.0 + 2.41 |
| | | (150) | (100) | (300) | (300) | (100) |
| PIX1OP | 82.8 + 6.48 | 84.3 + 4.63 | 85.0 ± 4.95 | 84.8 + 4.76 | 81.116.23 | 85.1 ± 4.30 |
| | | (150) | (200) | (200) | (300) | (50) |
| Prostate- | 1.95 + 0.27 | 1.5910.21 | 1.53 + 0.21 | 2.02 ± 0.25 | 2.86 + 0.00 | 336 ± 0.48 |
| GE | | (300) | (300) | (100) | (50) | (100) |

It was discovered that feature selection is necessary and effective. The selected subset of the features can not only reduce the computation cost, but also improve the clustering performance;

Robust analysis is also important for unsupervised feature selection, which helps select more relevant features and improve the performance;

The EUFS framework 100 tends to achieve better performance with usually fewer selected features such as 50 or 100; and most of the time, the proposed framework the EUFS framework 100 outperforms baseline methods, which demonstrates the effectiveness of the proposed algorithm. There are two major reasons. First, the feature selection is directly embedded in the process of clustering using sparse learning and the norm of the latent feature reflects the quality of the reconstruction and thus the importance of the original feature. Second, the graph regularize helps to learn better cluster indicators that fits the existing manifold structure, which leads to a better latent feature matrix. Finally, a robust analysis was introduced to ensure that these poorly reconstructed instances have less effect on feature selection.

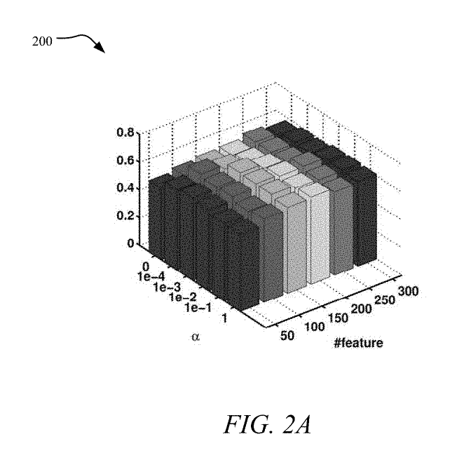

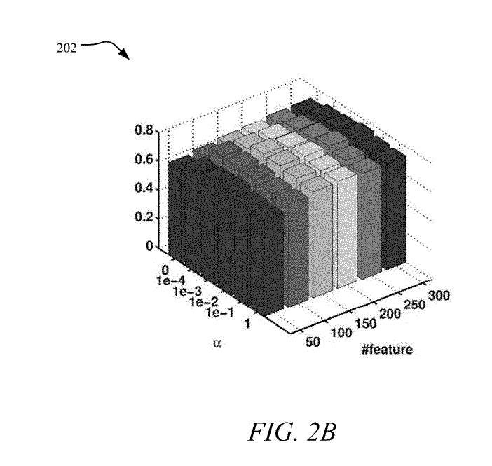

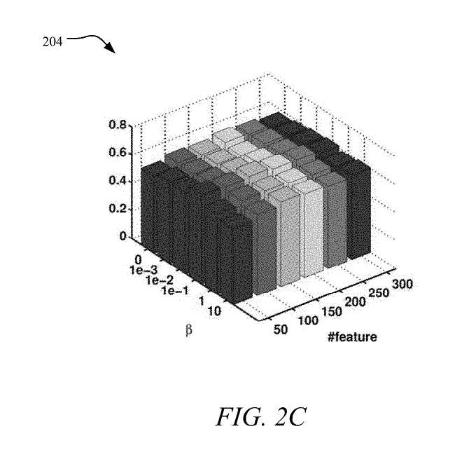

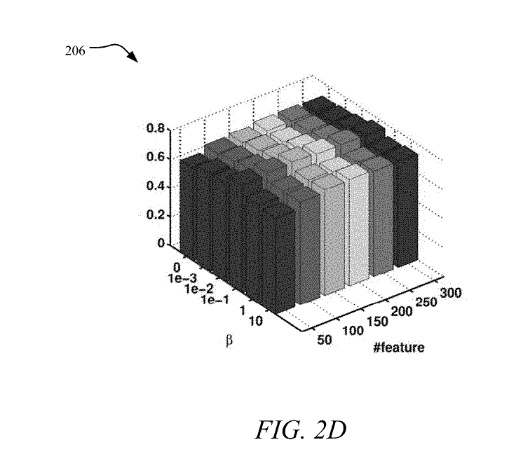

A parameter analysis is also performed for some important parameters of the EUFS framework 100. The results on COIL20 shown as graphs 200-206 are illustrated in FIGS. 2A-D. The experimental results show that the method is not very sensitive to α and β. However, the performance is relatively sensitive to the number of selected features, which is a common problem for many unsupervised feature selection methods.

FIG. 3 illustrates an example network environment 300 for implementing the various systems and methods, as described herein. As depicted in FIG. 3, a communications network 302 (e.g., the Internet) is used by one or more computing or data storage devices for implementing the systems and methods for managing high-dimensional data using the EUFS framework 100. In one implementation, one or more databases 302, such as a storage cluster, one or more computing devices 304, and/or other network components or computing devices described herein are communicatively connected to the communications network 302. Examples of the computing devices 304 include a terminal, personal computer, a mobile device, a smart-phone, a tablet, a multimedia console, a gaming console, a set top box, etc.

A server 306 hosts the system. In one implementation, the server 306 also hosts a website or an application that users may visit to access the high-dimensional data and/or the EUFS framework 100. The server 306 may be one single server, a plurality of servers 306 with each such server 306 being a physical server or a virtual machine, or a collection of both physical servers and virtual machines. In another implementation, a cloud hosts one or more components of the system. The computing devices 304, the server 306, and other resources connected to the communications network 302 may access one or more additional servers for access to one or more websites, applications, web services interfaces, etc. that are used for data management. In one implementation, the server 306 also hosts a search engine that the system uses for accessing and modifying information, including without limitation, high-dimensional data and/or algorithms of the EUFS framework 100.

Referring to FIG. 4, a detailed description of an example computing system 400 having one or more computing units that may implement various systems and methods discussed herein is provided. The computing system 400 may be applicable to the computing device 304, the server 306, and other computing or network devices. It will be appreciated that specific implementations of these devices may be of differing possible specific computing architectures not all of which are specifically discussed herein but will be understood by those of ordinary skill in the art.

The computer system 400 may be a computing system is capable of executing a computer program product to execute a computer process. Data and program files may be input to the computer system 400, which reads the files and executes the programs therein. Some of the elements of the computer system 400 are shown in FIG. 4, including one or more hardware processors 402, one or more data storage devices 404, one or more memory devices 408, and/or one or more ports 408-410. Additionally, other elements that will be recognized by those skilled in the art may be included in the computing system 400 but are not explicitly depicted in FIG. 13 or discussed further herein. Various elements of the computer system 400 may communicate with one another by way of one or more communication buses, point-to-point communication paths, or other communication means not explicitly depicted in FIG. 4.

The processor 402 may include, for example, a central processing unit (CPU), a microprocessor, a microcontroller, a digital signal processor (DSP), and/or one or more internal levels of cache. There may be one or more processors 402, such that the processor 402 comprises a single central-processing unit, or a plurality of processing units capable of executing instructions and performing operations in parallel with each other, commonly referred to as a parallel processing environment.

The computer system 400 may be a conventional computer, a distributed computer, or any other type of computer, such as one or more external computers made available via a cloud computing architecture. The presently described technology is optionally implemented in software stored on the data stored device(s) 404, stored on the memory device(s) 406, and/or communicated via one or more of the ports 408-410, thereby transforming the computer system 400 in FIG. 4 to a special purpose machine for implementing the operations described herein.

Examples of the computer system 400 include personal computers, terminals, workstations, mobile phones, tablets, laptops, personal computers, multimedia consoles, gaming consoles, set top boxes, and the like.

The one or more data storage devices 404 may include any non-volatile data storage device capable of storing data generated or employed within the computing system 400, such as computer executable instructions for performing a computer process, which may include instructions of both application programs and an operating system (OS) that manages the various components of the computing system 400. The data storage devices 404 may include, without limitation, magnetic disk drives, optical disk drives, solid state drives (SSDs), flash drives, and the like. The data storage devices 404 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 406 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 404 and/or the memory devices 406, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 400 includes one or more ports, such as an input/output (I/O) port 408 and a communication port 410, for communicating with other computing, network, or vehicle devices. It will be appreciated that the ports 408-410 may be combined or separate and that more or fewer ports may be included in the computer system 400.

The I/O port 408 may be connected to an I/O device, or other device, by which information is input to or output from the computing system 400. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 400 via the I/O port 408. Similarly, the output devices may convert electrical signals received from computing system 400 via the I/O port 408 into signals that may be sensed as output by a human, such as sound, light, and/or touch. The input device may be an alphanumeric input device, including alphanumeric and other keys for communicating information and/or command selections to the processor 402 via the I/O port 408. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing system 400 via the I/O port 408. For example, an electrical signal generated within the computing system 400 may be converted to another type of signal, and/or vice-versa. In one implementation, the environment transducer devices sense characteristics or aspects of an environment local to or remote from the computing device 400, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing device 400, such as, physical movement of some object (e.g., a mechanical actuator), heating or cooling of a substance, adding a chemical substance, and/or the like.

In one implementation, a communication port 410 is connected to a network by way of which the computer system 400 may receive network data useful in executing the methods and systems set out herein as well as transmitting information and network configuration changes determined thereby. Stated differently, the communication port 410 connects the computer system 400 to one or more communication interface devices configured to transmit and/or receive information between the computing system 400 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 410 to communicate one or more other machines, either directly over a point-to-point communication path, over a wide area network (WAN) (e.g., the Internet), over a local area network (LAN), over a cellular (e.g., third generation (3G) or fourth generation (4G)) network, or over another communication means. Further, the communication port 410 may communicate with an antenna or other link for electromagnetic signal transmission and/or reception.

In an example implementation, the EUFS framework 100 algorithms, including the clustering algoritm, and other software and/or modules and services may be embodied by instructions stored on the data storage devices 404 and/or the memory devices 406 and executed by the processor 402.

The system set forth in FIG. 4 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for managing high-dimensional data, the method comprising:
generating a data matrix for the high-dimensional data with a computing device, the data matrix having a plurality of rows with one or more features, each of the plurality of rows being a data instance; and
clustering the data matrix into one or more clusters using an embedded unsupervised feature selection framework, the embedded unsupervised feature selection framework selecting the one or more features in an unsupervised environment with sparse learning.

2. The method of claim 1, wherein the embedded unsupervised feature selection framework is generated based on a cluster indicator and a latent feature matrix.

3. The method of claim 2, wherein the latent feature matrix includes a sparse leaning technique, the embedded unsupervised feature selection framework selecting the one or more features via the latent feature matrix.

4. The method of claim 2, wherein the latent feature matrix and the cluster indicator are each set to 0 during initialization and subsequently converge to an optimal value.

5. The method of claim 1, wherein the embedded unsupervised feature selection framework is optimized using an Alternating Direction Method of Multiplier.

6. The method of claim 1, wherein the embedded unsupervised feature selection framework is optimized using a first equality constraint and a second equality constraint.

7. The method of claim 1, wherein the embedded unsupervised feature selection framework sorts the one or more features into a descending order.

8. The method of claim 7, wherein the embedded unsupervised feature selection framework selects one or more top ranked features from the descending order.

9. The method of claim 1, wherein the embedded unsupervised feature selection framework removes at least one of redundant, irrelevant, or noisy features of the high-dimensional data.

10. One or more non-transitory tangible computer-readable storage media storing computer-executable instructions for performing a computer process on a computing system, the computer process comprising:
generating a data matrix for high-dimensional data, the data matrix having a plurality of rows with one or more features, each of the plurality of rows being a data instance; and
clustering the data matrix into one or more clusters using an embedded unsupervised feature selection framework, the embedded unsupervised feature selection framework selecting the one or more features in an unsupervised environment with sparse learning.

11. The one or more non-transitory tangible computer-readable storage media of claim 10, wherein the embedded unsupervised feature selection framework is generated based on a cluster indicator and a latent feature matrix.

12. The one or more non-transitory tangible computer-readable storage media of claim 11, wherein the latent feature matrix includes a sparse leaning technique, the embedded unsupervised feature selection framework selecting the one or more features via the latent feature matrix.

13. The one or more non-transitory tangible computer-readable storage media of claim 11, wherein the latent feature matrix and the cluster indicator are each set to 0 during initialization and subsequently converge to an optimal value.

14. The one or more non-transitory tangible computer-readable storage media of claim 10, wherein the embedded unsupervised feature selection framework is optimized using Alternating Direction Method of Multiplier.

15. The one or more non-transitory tangible computer-readable storage media of claim 10, wherein the embedded unsupervised feature selection framework is optimized using a first equality constraint and a second equality constraint.

16. The one or more non-transitory tangible computer-readable storage media of claim 10, wherein the embedded unsupervised feature selection framework sorts the one or more features into a descending order.

17. The one or more non-transitory tangible computer-readable storage media of claim 16, wherein the embedded unsupervised feature selection framework selects one or more top ranked features from the descending order.

18. The one or more non-transitory tangible computer-readable storage media of claim 10, wherein the embedded unsupervised feature selection framework removes at least one of redundant, irrelevant, or noisy features of the high-dimensional data.

19. A system for managing high-dimensional data, the system comprising:
one or more databases storing the high-dimensional data; and
a computing device in communication with the one or more databases, the computing device clustering the data matrix for the high-dimensional data into one or more clusters using an embedded unsupervised feature selection framework, the data matrix having a plurality of rows with one or more features, the embedded unsupervised feature selection framework selecting the one or more features in an unsupervised environment with sparse learning.

20. The system of claim 19, wherein the embedded unsupervised feature selection framework is generated based on a cluster indicator and a latent feature matrix.
